(19) United States
(12) Patent Application Publication
(10) Pub. No.: US 2006/0171975 A1
(43) Pub. Date: Aug. 3, 2006

(54) Permeable packaging for liquid interactive preservatives or pesticides

(76) Inventor: Benjamin Alan Abbott, Humphrey, NE (US)

Correspondence Address: BENJAMIN ABBOTT, 41674 261 AVE., HUMPHREY, NE, 68642, US

(21) Appl. No.: 11/046,362

(22) Filed: Jan. 31, 2005

(51) Int. Cl. A01N 25/00

(52) U.S. Cl. 424/405

(57) ABSTRACT

A sealed tube filled and sized to achieve desired application rates for a given wood preservative to be applied internally to wooden structures. Tubing shall be composed as to permit osmotic activation and distribution into target site.

### DETAILED DESCRIPTION OF THE INVENTION

This invention is the application of liquid permeable packaging such as but not limited to pressed or woven natural or synthetic fibers sheets in the form of tubes, envelopes, or other packages to single use preservatives and pesticides with the intent of environmental liquids either ambient or added being able to move through the packaging as to interact with the dry preservative or pesticide. It is applicable to such preservatives or pesticides as require liquids to be applied with or present in the target site, either to alter the chemical nature of, or aid in the transportation of the pesticide or preservative.

1. What I claim is that my invention is liquid permeable material used for wood preservative or pesticide packaging with the intent of been applied as a unit to the target site.
